(19) United States
(12) Patent Application Publication
(10) Pub. No.: US 2004/0105279 A1
(43) Pub. Date: Jun. 3, 2004

(54) Light-emitting device with light softening cover

(76) Inventors: Daniel Liu, Hsin Tien (TW); Dragon Chang, Shindian City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/422,767

(22) Filed: Apr. 25, 2003

(30) Foreign Application Priority Data
Dec. 2, 2002 (TW) 91219431

(51) Int. Cl. F21V 7/04

(52) U.S. Cl. 362/555

(57) ABSTRACT

A light-emitting device is provided with a light diffusing shade corresponding to and enclosing a plurality of light-emitting elements of the light-emitting device to diffuse light beams emitted from the light-emitting elements, so that the diffused light beams are evenly projected toward an outer casing of the device. Therefore, the light-emitting device with the light diffusing shade solves the problem of intensified light spots presented on the outer casing of the light-emitting device using light-emitting diode as a light-emitting element thereof, and is suitable for cases where soft light is needed.

### BACKGROUND OF THE INVENTION

1. Field of the Invention

The present invention relates to a light-emitting device, and more particularly to a light-emitting device with light softening cover.

2. Description of the Prior Art

A light-emitting device may be used not only as an illuminating apparatus, but also a decoration. The light-emitting device will become more valuable and practical for use when light beams emitted therefrom are specially arranged to project in different manners and/or intensities. In most conventional light-emitting devices, an incandescent lamp or an energy-saving bulb is used as a light source thereof. However, such conventional light-emitting devices provide limited changes in the light beams emitted therefrom, and are therefore used mainly for common illumination.

To provide the conventional light-emitting devices with more changes in the emitted light beams, there is developed a light-emitting device using light-emitting diodes (LED) as a light source thereof. Since this type of light-emitting devices may be easily controlled via a control circuit to change flashing, on/off, and intensity of the emitted light beams, they are widely adopted in various decorating lighting fixtures, night lamps, etc.

When the light-emitting device uses a light-emitting diode as a light source thereof, the light beams emitted by the LED are directly projected toward external environments due to their excellent light beam condensing feature. Even if the light-emitting device is housed in a translucent casing, a relatively intense light spot is still visible on the translucent casing. However, areas on the translucent casing other than the intense light spot are relatively dark, making the entire light-emitting device visually unpleasant. When such conventional light-emitting device is used as a night lamp or night illuminator, it could not provide a soft visual effect at all.

### SUMMARY OF THE INVENTION

It is therefore a primary object of the present invention to provide a light-emitting device with light softening cover, so that light beams emitted therefrom are diffused and softened by the light softening cover.

Another object of the present invention is to provide a light-emitting device with structurally simple light softening structure. The light softening structure includes a simple light diffusing shade to diffuse and soften light beams emitted from the light-emitting device. When the light softening structure are applied to a lighting device including multiple LED type light-emitting elements, a better softening effect may be achieved.

With the technical means adopted by the present invention, light beams emitted from the LED type light-emitting elements in the light-emitting device are diffused and therefore softened. The light softening cover of the present invention is only a simple light diffusing shade. When the light softening cover is applied to a light-emitting device with a plurality of LED type light-emitting elements, or to a light-emitting device with a control circuit to control the brightness of the LED type light-emitting elements, an additional light softening effect, including gradual changed color and intensity may be achieved. The problem of intensified light spots presented on the surface of the casing of the conventional light-emitting devices due to the high brightness of the LED type light-emitting elements can therefore be largely improved.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein:

FIG. 1 is a perspective view of a light-emitting device with light softening cover according to a first embodiment of the present invention;

FIG. 2 is a partially exploded perspective view of FIG. 1 with an outer casing of the light-emitting device separated from a bottom casing thereof;

FIG. 3 is a fully exploded perspective view of FIG. 1 to show various components of the light-emitting device of the present invention;

FIG. 4 is a sectional view taken along line 4-4 of FIG. 1; and

FIG. 5 is a sectioned side view of a light-emitting device with light softening cover according to a second embodiment of the present invention.

### DETAILED DESCRIPTION OF THE PREFERRED EMBODIMENTS

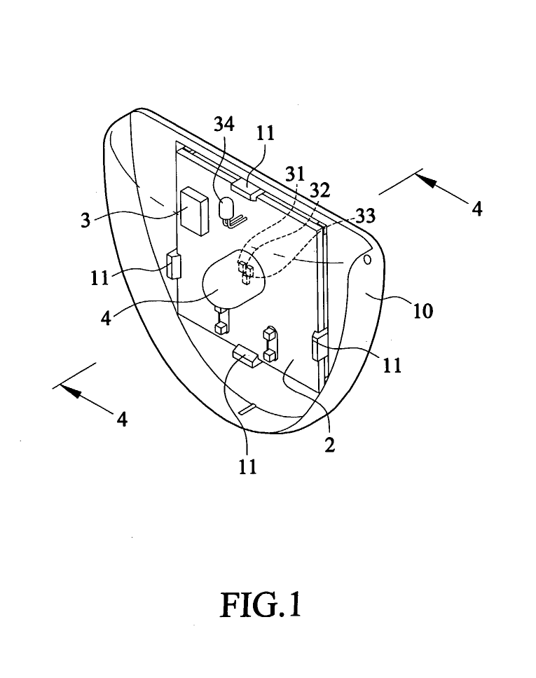

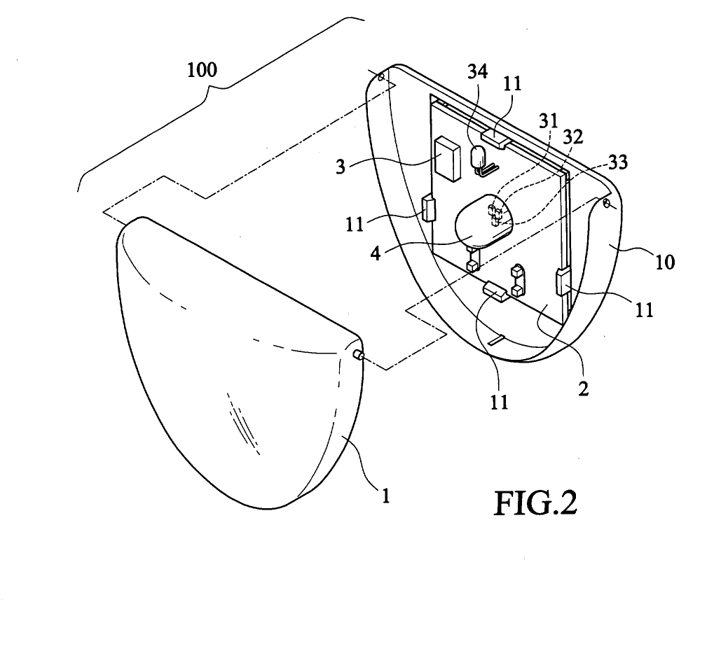

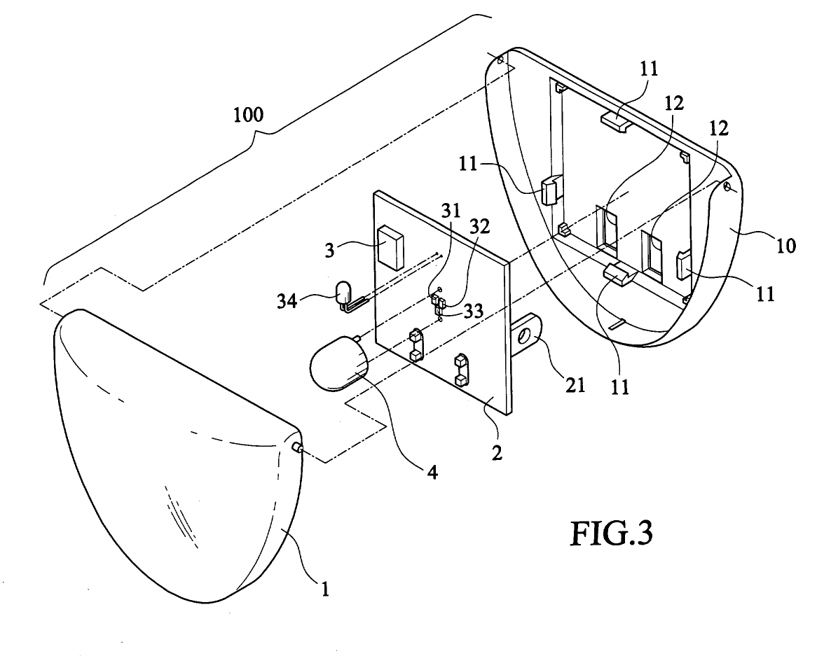

Please refer to FIGS. 1, 2, and 3 that are assembled, partially exploded, and fully exploded perspective views, respectively, of a light-emitting device with a light softening cover according to a first embodiment of the present invention. As shown, the light-emitting device of the present invention, which is generally denoted by a reference number 100, includes an outer casing 1, and a bottom casing 10 separably associated with the outer casing 1 to define an inner space therebetween. The bottom casing 10 is provided on an inner wall surface with a plurality of retaining hooks 11 for holding a circuit board 2 to the bottom casing 10. The circuit board 2 is provided at a rear side with at predetermined positions with two rearward projected conductive blades 21, which extend through two pre-formed slots 12 on the bottom casing 10 to project therefrom by a predetermined distance for inserting into a power receptacle (not shown).

The circuit board 2 is provided at a front side near a central area thereof with three light-emitting elements 31, 32, and 33 in the form of light-emitting diode (LED) to emit three different colors, for example, red (R), green (G), and blue (B). The R, G, and B light-emitting elements 31, 32, 33 are controlled by a control unit 3 to emit light beams simultaneously, or sequentially in a predetermined order, or gradually changing in a predetermined manner to create a color changing effect.

A light diffusing shade 4 is mounted on the circuit board 2 around the light-emitting elements 31, 32 and 33 to diffuse light beams projected from the light-emitting elements 31, 32 and 33, so that the diffused light beams are evenly projected toward the outer casing 1. The light diffusing shade 4 is made of light diffusible material, such as known polypropylene or polyethylene.

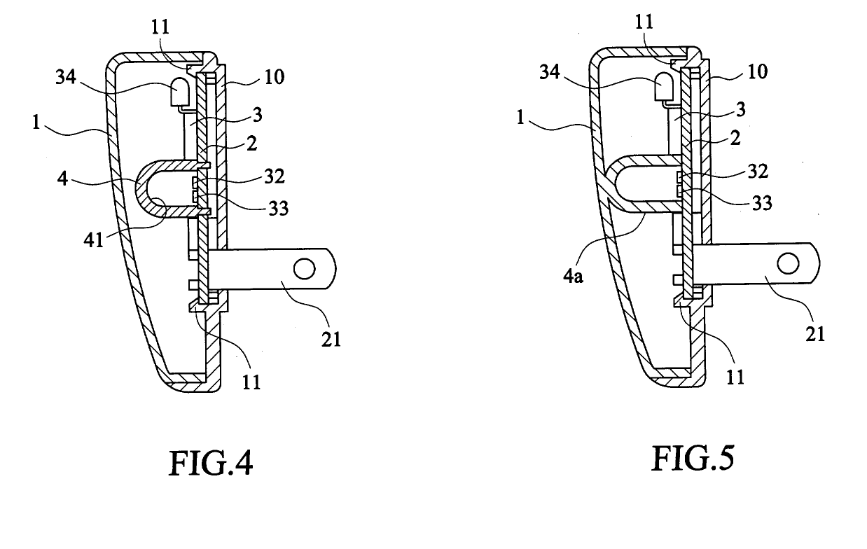

In the first embodiment of the present invention, the light diffusing shade 4 may be configured to be bell-shaped and defines an inner space 41 therein, as can be clearly seen from FIG. 4. When the light diffusing shade 4 is engaged to the circuit board 2, the light-emitting elements 31, 32, and 33 are located in the inner space 41 defined by the light diffusing shade 4.

The circuit board 2 is also provided with a direct projecting light-emitting element 34. Light beams emitted from the direct projecting light-emitting element 34 are directly projected toward an upper side of the outer casing 1. Therefore, the light-emitting device 100 not only presents softened light on a front side of the outer casing 1 but also a projected light at the upper side of the outer casing 1. When the light-emitting device 100 of the present invention is used, for example as a night lamp, an enhanced visual effect may be provided. The direct projecting light-emitting element 34 may be otherwise mounted on the circuit board 2 at other positions, and a plurality of the direct projecting light-emitting element 34 may be disposed to obtain an enhanced visual effect from the projected light beams.

FIG. 5 shows a sectional view of a light-emitting device according to a second embodiment of the present invention. The second embodiment of the present invention is generally structurally similar to the first embodiment, except that a light diffusing shade 4a thereof is formed on an inner wall surface of the outer casing 1. The light diffusing shade 4a is positioned in relation to the light-emitting elements 31, 32, and 33 on the circuit board 2 from where light beams are projected, so that the outer casing 1 is engaged to a front side of the bottom casing 10 and the circuit board 2, the light diffusing shade 4a on the outer casing 1 encloses the light-emitting elements 31, 32, and 33 to diverge light beams emitted therefrom, so that the diffused light beams may be evenly projected toward the outer casing 1.

In brief, the light-emitting device with light softening cover according to the present invention uses the light diffusing shade 4 or 4a to effectively diffuse and soften light beams emitted by the light-emitting elements 31, 32, 33 included in the light-emitting device 100. Moreover, when the light-emitting device 100 includes a plurality of LED-type light-emitting elements for providing light beams in different manners or in different intensities through control of a control unit, a gradually changeable lighting effect may be achieved.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. A light projecting device, comprising:
an outer casing defining an inner space therein;
at least one light-emitting element being disposed within on the casing for projecting a light beam; and
a light diffusing shade substantially enclosing at least one light-emitting element and diffusing the light beam projected from the light-emitting element toward the casing.

2. The light projecting device as claimed in claim 1, wherein the light diffusing shade is configured to be bell-shaped and defines an inner space, whereby the light-emitting element is enclosed in the inner space defined in the light diffusing shade.

3. The light projecting device as claimed in claim 1 comprising a plurality of light-emitting elements of different color lights.

4. The light projecting device as claimed in claim 1, wherein the light-emitting element is a light-emitting diode (LED).

5. The light projecting device as claimed in claim 1 further comprising two conductive plates projected from one side surface of the outer casing for inserting into a power receptacle.

6. The light projecting device as claimed in claim 1 further comprising at least one direct projective lighting element disposed within said casing, and light beams emitted from the direct projective lighting element being directly projected toward the outer casing.

7. A light projecting device, comprising:
an outer casing defining an inner space therein;
at least one light-emitting element being disposed within the casing for projecting a light beam; and
a light diffusing shade formed on an inner wall surface of the outer casing and positioned so that the light diffusing shade substantially encloses the light emitting element and light beams projected from the light-emitting element are diffused.

8. The light projecting device as claimed in claim 7, wherein the light diffusing shade is configured to be bell-shaped and defines an inner space, whereby the light-emitting element is enclosed in the inner space defined in the light diffusing shade.

9. The light projecting device as claimed in claim 7 comprising a plurality of light-emitting elements of different color lights.

10. The light projecting device as claimed in claim 7, wherein the light-emitting element is a light-emitting diode (LED).

11. The light projecting device as claimed in claim 7 further comprising two conductive plates projected from one side surface of the outer casing for inserting into a power receptacle.

12 The light projecting device as claimed in claim 7 further comprising at least one direct projective lighting element disposed within said casing, and light beams emitted from the direct projective lighting element being directly projected toward the outer casing.
